(19) United States
(12) Patent Application Publication
(10) Pub. No.: US 2007/0289014 A1
(43) Pub. Date: Dec. 13, 2007

(54) Network security device and method for processing packet data using the same

(75) Inventors: Seung Jong Pyo, Seoul City (KR); Yeon Sik Ryu, Suwan City (KR); So Ra Son, Anyang City (KR)

Correspondence Address: BIRCH STEWART KOLASCH & BIRCH, PO BOX 747, FALLS CHURCH, VA, 22040-0747, US

(73) Assignee: LG N-Sys Inc., Seoul City (KR)

(21) Appl. No.: 11/790,249

(22) Filed: Apr. 24, 2007

(30) Foreign Application Priority Data
Apr. 25, 2006 (KR) 10-2006-0037342

(51) Int. Cl. G06F 11/00

(52) U.S. Cl. 726/22

(57) ABSTRACT

The present invention relates to a multiple host-based network security device and a method for processing packet data using the network security device. The multiple host-based network security device of the present invention comprises at least two individual hosts in a single host system. Each of the individual hosts comprises individual resources such as a central processing unit (CPU) and a memory, and performs a different task in a single host system. The network security device comprises a packet policy module for providing a packet classification policy such that packet data are sent properly to the individual hosts, and a packet processing unit for sending the packet data to a relevant individual host according to the packet classification policy and providing services or blocking the packet data in accordance with packet checking results performed in the individual hosts. Thus, the data processing performance can be improved and the packet data can be stably checked.

### BACKGROUND

1. Field

The present invention relates to network security, and more particularly, to a multiple host-based network security device for processing packet data in which at least two individual hosts are provided in a single host system, and a method for processing the packet data using the network security device.

2. Description of the Related Art

As the use of computers and the Internet has been widely spread, users spend more time in front of computers and network security is also considered as an important factor. Network security prevents intrusion through vulnerable points such as an operating system, a server and an application program of a computer system connected to a network or illegal intrusion from the outside and illegal access to internal information.

To this end, hardware-based or software-based network security devices have been conventionally used. FIGS. 1a and 1b illustrate the configuration of conventional hardware-based and software-based network security devices, respectively.

Packet data are processed in the network security device of FIG. 1a, as follows.

When the packet data are received via an interface 1, a pattern matching engine 5 of a first security module 3 checks a header and content of the packet data based on already loaded information on the blocking policy. If it is determined in the matching engine 5 that matched packet data exist, a processing engine 7 blocks or bypasses the relevant packet data in accordance with a previously stored policy. The processing results and the bypassed packet in the first security module 3 are sent to a second security module 11 via a peripheral component interconnect (PCI) interface 9.

When receiving the packet, a main central processing unit (CPU) 13 of the second security module 11 checks whether the received packet is an attempt to make dynamic attacks, e.g., denial-of-service (DoS) attack and a distributed denial-of-service (DDoS) attack, based on a threshold. The main CPU returns the check results to the pattern matching engine 5 of the first security module 3. Then, the pattern matching engine 5 determines whether to block the packet traffic.

The packet data in the network security device of FIG. 1b will be processed as follows.

Security function modules 24, 26 or 28 receives a packet via a network card 20 over a network, and checks the packet using software under the control of a main CPU 22. At least one of the security function modules is selectively provided.

However, this conventional security device has the following problems.

The security device provides only one host to a single system. That is, since the main CPU 13 or 22 performs a general security function, several security functions cannot be performed due to the limited hardware resource.

For example, in the security device of FIG. 1a, when the packet data pattern is not matched with the stored pattern, it is necessary to check in detail whether the packet is an attempt to make dynamic attacks (e.g., DoS and DDOS). However, limited hardware resources in connection with a CPU and a memory have made it difficult to perform such a high-level security function. In the security device of FIG. 1b, one or more security function modules 24, 26 and 28 are provided to perform several security functions, but the security device exhibits limited performance because the main CPU 22 should perform all the security functions.

Furthermore, the security device cannot process traffics for a large amount of packet data because it is based on a single host. Although the single host-based security device attempts to process a large amount of the packet data, non-processed packet data increase due to the processing time delay. Accordingly, the packet data may be lost.

### SUMMARY

The present invention is conceived to solve the aforementioned problems. Accordingly, an object of the present invention is to provide a network security device for processing packet data wherein a plurality of hosts each having resources such as a central processing unit and a memory are provided in a single system, and a method for processing packet data using the network security device.

Another object of the present invention is to perform several security functions using at least two individual hosts.

A further object of the present invention is to simultaneously process a large amount of packet data using at least two individual hosts.

According to an aspect of the present invention for achieving the objects, there is provided a network security device, comprising at least two hosts for performing security functions, respectively, according to different security policies; and a packet processing unit for sending packet data received via a network to a host having a first priority according to a packet classification policy by which predetermined priorities are assigned to the respective hosts, and sequentially sending, if it is determined by the host that the packet data are normal, the normal packet data to hosts having the next priorities to continuously perform the security functions.

The packet processing unit may block the packet data, if it is determined by any one of the hosts that the packet data are harmful.

Each of the hosts may comprise individual resources including a central processing unit (CPU) and a memory to perform a different task within a single host system.

Preferably, each of the hosts performs any one selected from the group of consisting of a firewall/quality of service (QoS) security function, an intrusion detection security function and a dynamic and session-processing security function.

According to another aspect of the present invention, there is provided a network security device, comprising at least two hosts for processing packet data, respectively, in correspondence with transmission protocols of the packet data; a packet processing unit for classifying the packet data according to the transmission protocols with reference to a packet classification policy and sending the classified packet data to a relevant host; and a packet policy module for providing the packet classification policy to the packet processing unit.

When receiving two or more packet data, the packet processing unit may send the packet data in parallel to the relevant hosts according to the packet classification policy to allow the hosts to simultaneously process the received packet data.

Preferably, the hosts process transmission control protocol (TCP), user datagram protocol (UCP)/internet control message protocol for IP version (ICMP) and hypertext transfer protocol (HTTP) packets.

According to a further aspect of the present invention, there is provided a method for processing packet data using a network security device, the method comprising the steps of receiving packet data via a network; sending the packet data to a host having a first priority among at least two hosts having different security policies; determining by the host having the first priority whether the packet data are normal, using its own security policy; and sending the packet data to a host having the next priority if it is determined that the packet data are normal and blocking the packet data if it is determined that the packet data are harmful.

The packet data may be sequentially sent to and checked by all the hosts having priorities.

If it is determined by any one of the hosts that the packet data are harmful, the packet data may be blocked.

The packet data may be checked at least once.

According to a still further aspect of the present invention, there is provided a method for processing packet data using a network security device, comprising the steps of classifying packet data received via a network; sending the classified packet data to two or more relevant hosts; and processing the packet data.

Further, the packet data classified into at least two data may be simultaneously sent to the relevant hosts.

Furthermore, the packet data may be classified according to transmission protocols, and the hosts may receive and process relevant packet data among the packet data with different transmission protocols.

The hosts may operate individually in a single host system to simultaneously perform different tasks.

According to the present invention so configured, several security functions can be applied to packet data collected over the network and a plurality of packet data can be simultaneously processed to thereby increase a packet processing rate.

### BRIEF DESCRIPTION OF THE DRAWINGS

The above and other aspects, features and advantages of the present invention will become apparent from the following description of preferred embodiments given in conjunction with the accompanying drawings, in which:

FIGS. 1a and 1b are block diagrams illustrating conventional hardware-based and software-based network security devices;

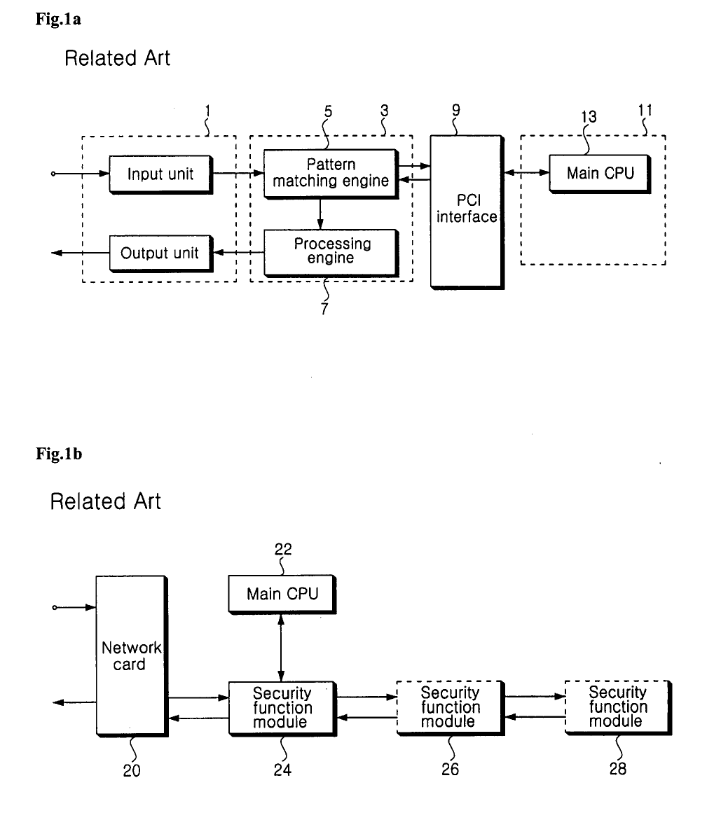

FIG. 2 is a block diagram illustrating the configuration of a network security device according to a first embodiment of the present invention;

FIG. 3 is a flowchart illustrating a method for processing packet data in the network security device according to the first embodiment of the present invention;

FIG. 4 is a block diagram illustrating the configuration of a network security device according to a second embodiment of the present invention; and

FIG. 5 is a flowchart illustrating a method for processing packet data in the network security device according to the second embodiment of the present invention.

### DETAILED DESCRIPTION

Preferred embodiments of network security devices and methods for processing packet data using the security device according to the present invention will be described in detail with reference to the accompanying drawings.

In the preferred embodiments of the present invention, a multiple host-based security device is provided in which at least two hosts (hereinafter, referred to as individual hosts) are operated in a single host system. Each of the individual hosts comprises resources such as a central processing unit (CPU) and a memory. The individual hosts perform any tasks in parallel. That is, the individual hosts can perform different tasks in a single host system.

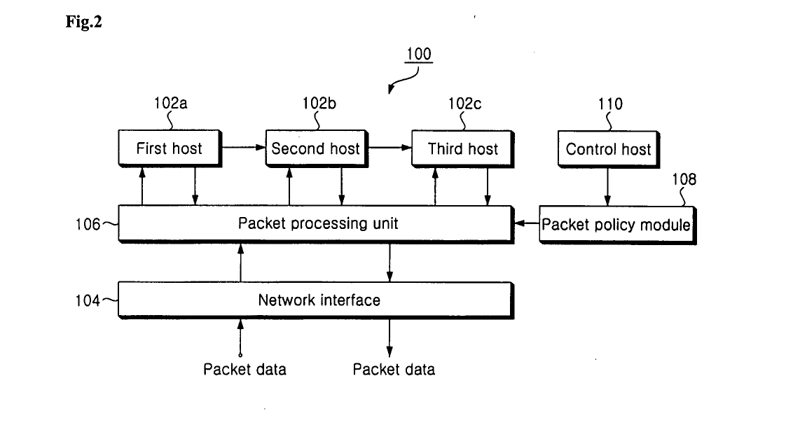

FIG. 2 is a block diagram illustrating the configuration of a network security device according to a first embodiment of the present invention. In the first embodiment of FIG. 2, multiple security functions are carried out with respect to packet data.

Referring to FIG. 2, a single host system (i.e., a security device) 100 is provided with at least two individual hosts. As an individual host, there are provided first to third hosts 102a to 102c. The first to third hosts 102a to 102c provide different security functions, respectively. That is, the first host 102a provides a firewall/quality of service (QoS) security function, the second host 102b provides an intrusion detection security function, and the third host 102c provides a dynamic and session-processing security function.

At least two of the first to third hosts 102a to 102c should be operated, and all the individual hosts 102a to 102c provided in the host system 100 are preferably operated to perform multiple security functions.

A packet processing unit 106 is provided to send packet data received through a network interface 104 to any one of the individual hosts 102a to 102c such that the individual host checks whether the packet data are harmful, and to block the packet data when the packet data are harmful or otherwise to continuously perform the security function by sending the packet data to the other individual hosts when the packet data are normal.

The packet processing unit 106 sends the packet data to the first individual host in accordance with a packet classification policy in which priorities of the individual hosts are specified. In the first embodiment of the present invention, the packet data are sent in order of the first host 102a, the second host 102b and the third host 103c. Although the priorities are specified in order of the first, second and third hosts 102a, 102b and 102c in accordance with the packet classification policy, the packet data will be sent from the first host 102a directly to the third host 102c when the second host 102b is disabled.

A packet policy module 108 for providing the packet classification policy is also provided. The packet policy module 108 may be arbitrarily modified by a network manager. The packet policy module 108 stores information on an individual host to which packet data are to be first sent and on a transfer path from an individual host to another individual host. In some cases, the packet data may be simultaneously sent to the first to third hosts 102a to 102c to perform the security functions.

A control host 110 is further provided to manage the first to third hosts 102a to 102c and to control the packet policy module 108 such that the packet classification policy can be normally applied to the packet processing unit 106.

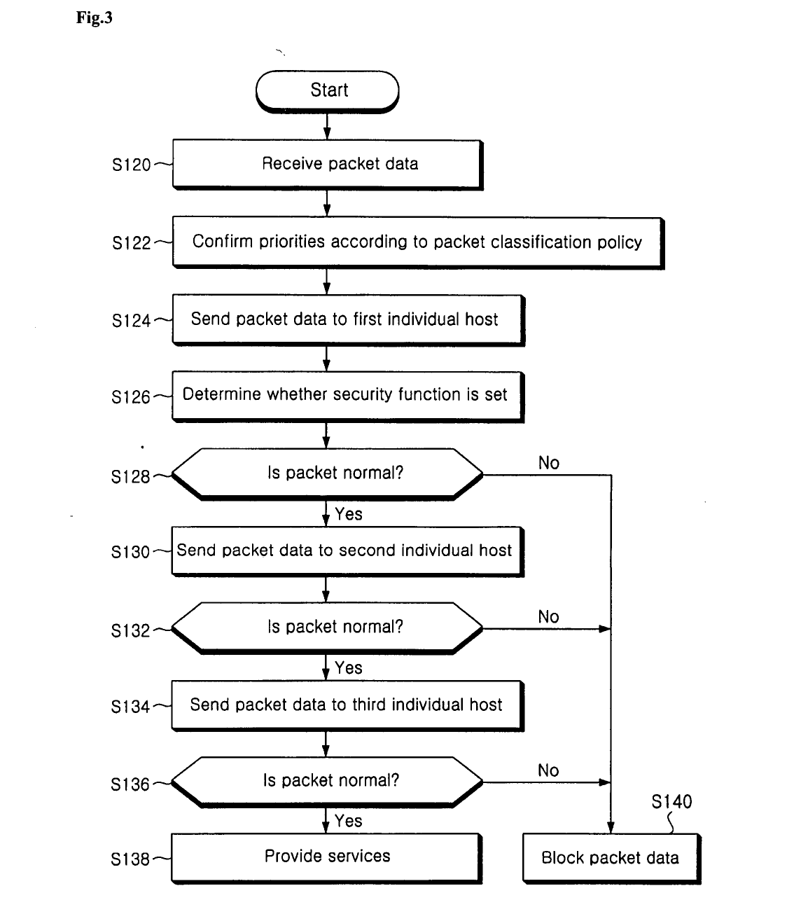

Next, a process of performing multiple security functions on the packet data according to the first embodiment of the present invention will be described with reference to FIG. 3.

First, the individual hosts, i.e. the first to third hosts 102a to 102c, provided in the host system 100 are driven by a manager, and the packet data are then input via the network interface 104 (S120).

The packet data are sent to the packet processing unit 106, which in turn confirms the priorities of the individual hosts based on the packet classification policy provided by the packet policy module 108 (S122). After confirming the priorities of the individual hosts, the packet processing unit 106 sends the packet data to the first host 102a having the first priority among the first to third host 102a to 102c (S124).

The first host 102a for providing the firewall/QoS security function determines whether the firewall/QoS security function is set for the packet data (S126). If the packet data are data which will be blocked by the firewall/QoS security function, the first host 102a determines that the received packet data are harmful (‘No’ in S128) and sends the determination results to the packet processing unit 106. Then, the packet processing unit 106 blocks the packet data so that services for the packet data are not performed (S140).

On the other hand, when the first host 102a determines that the packet data are normal packets (‘Yes’ in S128), the packet processing unit 106 sends the packet data to the second host 102b having the next priority (S130). The reason of performing another security function is that the host system 100 may be damaged when the packet data are exposed to other attacks or when the first host erroneously determines that the packet data are normal traffic.

After receiving the packet data, the second host 102b determines whether the packet data are harmful in accordance with the intrusion detection security function. This determination is based on a series of rules (i.e., security policy) set by the network manager or on an analysis of packet streams collected for a certain period of time to detect a variety of types of attacks.

If it is determined by the second host 120b that the packet data are harmful (‘No’ in S132), the second host 102b sends the determination results to the packet processing unit 106 which in turn blocks the packet data (S140). On the other hand, it is determined that the packet data are normal, the packet processing unit 106 sends the packet data to the third host 102c which will in turn perform the dynamic and session-processing security function (S134).

The third host 102c for performing the dynamic and session-processing security function checks whether the packet data, which have been determined as the normal packet by the second host 102b, are harmful. If it is determined that the packet data are harmful (‘No’ in S136), the packet data are completely blocked such that relevant services are not provided (S140). On the other hand, if it is determined that the packet data are normal, the packet data are sent to a destination such that the relevant services are normally provided (S138).

In the first embodiment, the individual hosts 102a to 102c having the different security functions are driven in the host system 100 to perform the multiple security functions on the packet data. In particular, the individual hosts 102a to 102c may be properly modified in accordance with the network device characteristics and the user requirements. In addition to the first to third hosts 102a to 102c, additional individual hosts having other security functions may be provided. On the other hand, the first to third hosts 102a to 102c may be replaced with hosts with other security functions.

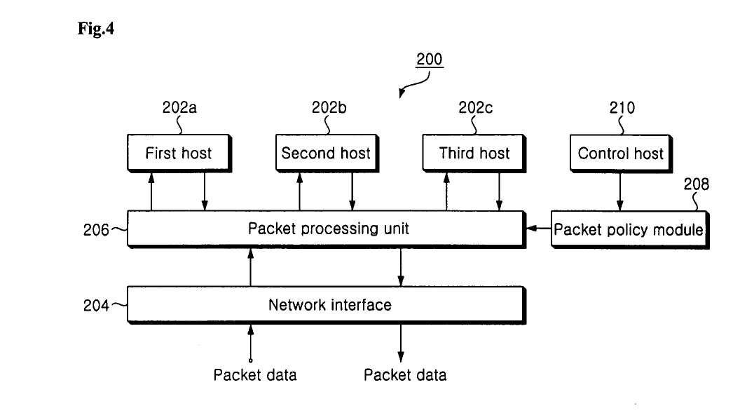

Another network security device comprising a plurality of individual hosts with different functions from the individual hosts of the first embodiment is shown in FIG. 4. FIG. 4 is a block diagram illustrating the configuration of a network security device according to a second embodiment of the present invention.

Referring to FIG. 4, at least two individual hosts, e.g. first to third hosts 202a to 202c are provided in a single host system (i.e., a security device) 200.

The first to third hosts 202a to 202c provide a processing and security function for packet data with different transmission protocols. Specifically, depending on the transfer protocols of the packet data, the first host 202a may process packet data with transmission control protocol (TCP), the second host 202b may process packet data with user datagram protocol (UDP)/Internet control message protocol for IP version (ICMP), and the third host 202c may process packet data with hypertext transfer protocol (HTTP).

A packet processing unit 206 is further provided to classify packet data collected through a network interface 204 in accordance with a packet classification policy by transmission protocols with reference to a header of the packet data, and to send the classified packet data to respective relevant first to third hosts 202a to 202c. When receiving a number of packet data with different transmission protocols, the packet processing unit 206 may simultaneously send the packet data to the first to third hosts 202a to 202c.

A packet policy module 208 for providing the packet classification policy to the packet processing unit 206 is also provided. The packet policy module 208 provides the packet classification policy by which packet data of TCP protocol are sent to the first host 202a, packet data of UDP/ICMP protocol are sent to the second host 202b, and packet data of HTTP protocol are sent to the third host 202c. It will be easily understood that the packet classification policy may be modified when additional transmission protocols for packet data are provided or individual hosts for processing different transmission protocols are further provided.

A control host 210 is further provided to manage the first to third hosts 202a to 202c and to control the packet policy module 208 such that the packet classification policy can be normally applied to the packet processing unit 206.

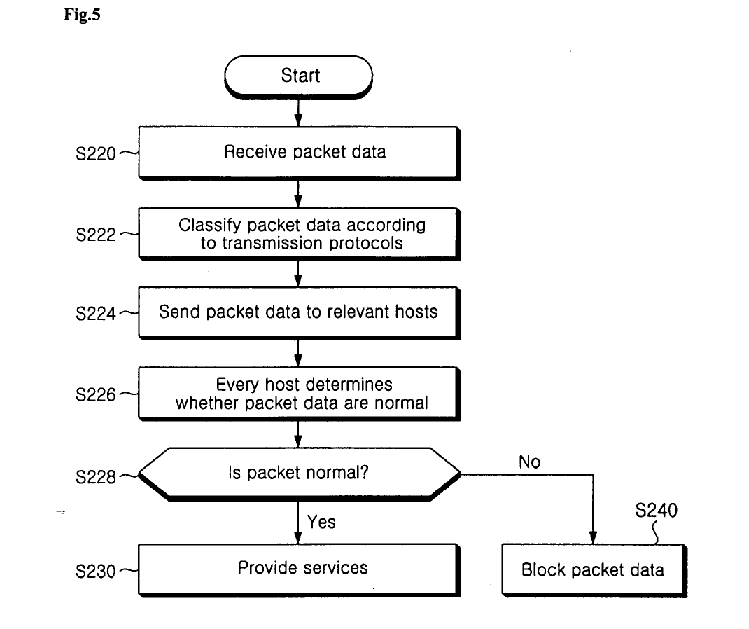

Next, a process of simultaneously performing security functions on packet data according to the second embodiment of the present invention will be described with reference to FIG. 5

First, the individual hosts, i.e. the first to third hosts 202a to 202c of the host system 200, are driven by a manager and the packet data are input via the network interface 204 (S220).

The packet data are sent to the packet processing unit 206 which in turn classifies the packet data in accordance with a transmission protocol for the packet data using the packet classification policy provided by the packet policy module 208 (S222).

The packet processing unit 206 sends the classified packet data to a relevant individual host in accordance with the transmission protocol (S224). The packet processing unit 206 may confirm the transmission protocol from the transfer protocol information present in a header of the packet data and then classify the packet data according to the transmission protocols. When the packet data are input, the TCP packet data are sent to the first host 202a, the UDP/ICMP packet data are sent to the second host 202b and the HTTP packet data are sent to the third host 202c. Even when the TCP packet data, the UDP/ICMP packet data and the HTTP packet data are not sequentially but simultaneously input via the network interface 204, the packet processing unit 206 can classify the packet data according to the packet classification policy and send the classified data to the hosts. Further, even when some of the packet data (i.e., only the TCP packet data and the HTTP packet data) are input, the packet processing unit 206 can send the TCP packet data to the first host 202a and the HTTP packet data to the third host 202c.

Each CPU of the first to third hosts 202a to 202c compares the received packet data with previously provided blocking policy information to determine whether the packet data are normal (S226).

If it is determined in step S228 that the packet data are normal, the relevant individual host normally provides services (S230). However, if it is determined that the packet data are harmful, the relevant individual host sends the determination results to the packet processing unit 206 which in turn blocks the packet data with reference to the received determination result to prevent the services from being provided by the relevant individual host (S240). At this time, the packet data may be blocked not by the packet processing unit 206 but by the individual host.

A conventional single host-based security device is difficult to process a large amount of packet data because of its insufficient hardware resources. In the present embodiment, however, a plurality of the individual hosts 202a to 202c receive and process packet data corresponding to their own transmission protocols, so that the data processing performance can be improved.

In the present invention, various kinds of security devices can be implemented according to the selection of desired individual hosts and simultaneously process a large amount of packet data. For example, the individual hosts 202a to 202c determine whether the packet data are harmful, and provide desired services when the packet data are normal or block the packet data when the data are harmful.

As described above, the network security device and the method for processing packet data using the network security device according to the present invention have the following advantages:

A performance problem inherent to a single host-based security device can be solved.

That is, since multiple security functions can be easily applied to packet data, it can be substantially checked in a short time whether the packet data are normal.

Further, a large amount of packet data with different transmission protocols can be sent to and simultaneously processed in the relevant hosts. Therefore, the packet data processing performance can be improved.

Furthermore, since the packet classification policy can be modified by a user, the individual hosts can be disposed suitably according to the characteristics of the security device based on the packet classification policy, thereby providing a variety of security functions.

While the present invention has been illustrated and described in connection with the accompanying drawings and the preferred embodiments, the present invention is not limited thereto and is defined by the appended claims. Therefore, it will be understood by those skilled in the art that various modifications and changes can be made thereto without departing from the spirit and scope of the invention defined by the appended claims.

What is claimed is:

1. A network security device, comprising:
at least two hosts for performing security functions, respectively, according to different security policies; and
a packet processing unit for sending packet data received via a network to a host having a first priority according to a packet classification policy by which predetermined priorities are assigned to the respective hosts, and sequentially sending, if it is determined by the host that the packet data are normal, the normal packet data to hosts having the next priorities to continuously perform the security functions.

2. The device as claimed in claim 1, wherein the packet processing unit blocks the packet data if it is determined by any one of the hosts that the packet data are harmful.

3. The device as claimed in claim 1, wherein each of the hosts comprises individual resources including a central processing unit (CPU) and a memory to perform a different task within a single host system.

4. The device as claimed in claim 1, wherein each of the hosts performs any one selected from the group of consisting of a firewall/quality of service (QoS) security function, an intrusion detection security function and a dynamic and session-processing security function.

5. A network security device, comprising:
at least two hosts for processing packet data, respectively, in correspondence with transmission protocols of the packet data;
a packet processing unit for classifying the packet data according to the transmission protocols with reference to a packet classification policy and sending the classified packet data to a relevant host; and
a packet policy module for providing the packet classification policy to the packet processing unit.

6. The device as claimed in claim 5, wherein when receiving two or more packet data, the packet processing unit sends the packet data in parallel to the relevant hosts according to the packet classification policy to allow the hosts to simultaneously process the received packet data.

7. The device as claimed in claim 5, wherein the hosts process transmission control protocol (TCP), user datagram protocol (UCP)/internet control message protocol for IP version (ICMP) and hypertext transfer protocol (HTTP) packets.

8. A method for processing packet data using a network security device, the method comprising the steps of:
receiving packet data via a network;
sending the packet data to a host having a first priority among at least two hosts having different security policies;
determining by the host having the first priority whether the packet data are normal, using its own security policy; and
sending the packet data to a host having the next priority, if it is determined that the packet data are normal.

9. The method as claimed in claim 8, wherein the packet data are sequentially sent to and checked by all the hosts having priorities.

10. The method as claimed in claim 9, wherein if it is determined by any one of the hosts that the packet data are harmful, the packet data are blocked.

11. The method as claimed in claim 8, wherein the packet data are checked at least once.

12. The method as claimed in claim 8, wherein the hosts operate individually in a single host system to perform different tasks.

13. A method for processing packet data using a network security device, the method comprising the steps of:
classifying packet data received via a network;
sending the classified packet data to two or more relevant hosts; and
processing the packet data.

14. The method as claimed in claim 13, wherein the packet data classified into at least two data are simultaneously sent to the relevant hosts.

15. The method as claimed in claim 13, wherein the packet data are classified according to transmission protocols, and the hosts receive and process relevant packet data among the packet data with different transmission protocols.

16. The method as claimed in claim 13, wherein the hosts operate individually in a single host system to simultaneously perform different tasks.
